(19) United States
(12) Patent Application Publication
(10) Pub. No.: US 2009/0189533 A1
(43) Pub. Date: Jul. 30, 2009

(54) Dual colored LED decoration lamp

(76) Inventor: Fu-Hsien Hsu, Chung Ho City (TW)

Correspondence Address: LEONG C LEI, PMB # 1008, 1867 YGNACIO VALLEY ROAD, WALNUT CREEK, CA, 94598, US

(21) Appl. No.: 12/010,666

(22) Filed: Jan. 29, 2008

(51) Int. Cl. F21S 4/00

(52) U.S. Cl. 315/185 S

(57) ABSTRACT

A dual colored LED decoration lamp which includes a lamp string combined of multiple dual colored LED lamps and a controller connected between the power supply and the lamp string. The lamp string includes lamp groups combined of multiple LED lamps with two different colors and with their anodes and cathodes cross-linked. The multiple lamp groups are then connected in series, and each LED lamp in every lamp group is connected in same direction with the same colored LED lamp in the next lamp group. The controller controls the variation of the direction of current in aforementioned lamp strings. Thus, the lamp string is able to emit light with different colors by varying the current direction in the same lamp string through the usage of controller, and there is no need to set with multiple lamp strings.

### FIELD OF THE INVENTION

This preferred embodiment is related to a kind of decoration lamp, and more specifically is related to a kind of dual colored LED decoration lamp with the capability of switching two kinds of colors.

### BACKGROUND OF THE INVENTION

A multiple colored LED decoration lamp can change multiple colors according to the requirement and emit colorful lights to bring up the decoration effect of the surrounding environment. For example in FIGS. 1 and 2, the known LED decoration lamps with exchangeable dual colors normally are linked in parallel with lamp strings with two colors then serial linked with controllers. By controlling the conduction of time sequences of the circuitry where the lamp strings with different colors mounted through the controller, the string lamps with different colors can be lightened at different time period and the color varying effects are thus achieved in the whole LED decoration lamp. The linkage of the whole LED decoration lamp needs three conductive wires with different polarities due to the setup of two circuitries. Simultaneously, a lamp group is then formed with assembling the LED lamps together in the lamp strings with different colors. Certain distances are set between different groups based on the requirement which making the required volume become larger in this kind of decoration lamp and hard to be used.

### SUMMARY OF THE INVENTION

The technical problem to be solved in the present invention is to provide a kind of dual colored LED lamp with a simpler linking structure and smaller volume that can supplement the disadvantages of the dual colored LED decoration lamp with complex structure in the prior art.

The technical plan of the present invention adopted to solve the aforementioned technical problem is: a kind of dual colored LED decoration lamp which including a lamp string combined of multiple dual colored LED lamps and a controller connected between the power supply and the aforementioned lamp string. The aforementioned lamp string is included with lamp groups combined of multiple LED lamps with two different colors and with their anodes and cathodes cross-linked. The aforementioned multiple lamp groups are then serial linked together, and each LED lamp in every lamp group is connected in same direction with the same colored LED lamp in the next lamp group. The aforementioned controller controls the variation of the direction of current in aforementioned lamp strings.

In the dual colored decoration lamp described in the present invention, two upper LED lamps in the aforementioned lamp group are set inside one lamp body.

In the dual colored decoration lamp described in the present invention, the aforementioned controller connects with the power supply through the plug.

The implement of LED decoration lamp in the present invention has the following benefits: The aforementioned lamp string through setup is formed with multiple lamp-groups serial linked together. Two LED lamps with different colors and with their anodes and cathodes cross-linked are included in each lamp group. The same colored LED lamps to be linked in the same direction are guaranteed while multiple lamp groups are serial linked together to form lamp strings.

Thus, the lamp string is able to emit light with different colors by varying the current direction in the same lamp string through the usage of controller, and there is no need to set with multiple lamp strings. The linkage structure becomes simpler. The LED lamps with two different colors in the same lamp group are set in the same lamp body to make the volume of the whole LED decoration lamp smaller and to be hanged or wrapped conveniently on the materials needs to be decorated while usage.

### BRIEF DESCRIPTION OF THE DRAWINGS

The further description of the preferred embodiment will be described hereafter by combining with the attached drawings and implement examples. In attached drawings:

FIG. 1 is a theoretical schematic circuit drawing of the dual colored LED decoration lamp in the prior art.

FIG. 2 is a drafted structural drawing of the dual colored LED decoration lamp in the prior art.

FIG. 3 a theoretical schematic circuit drawing of the dual colored LED decoration lamp according to the present invention.

FIG. 4 is a drafted structural drawing of the dual colored LED decoration lamp of the present invention.

FIG. 5A to 5G are drafted implement drawings of the setting chips inside the dual colored LED decoration lamp of the present invention.

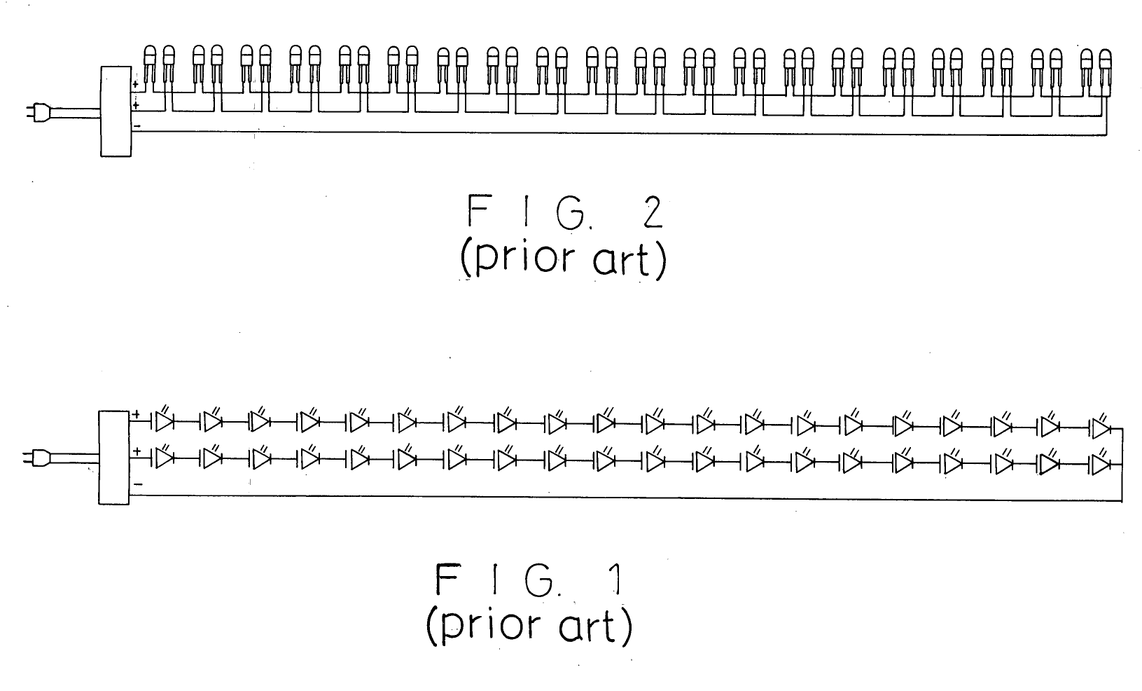

### DETAILED DESCRIPTION OF THE PREFERRED EMBODIMENT

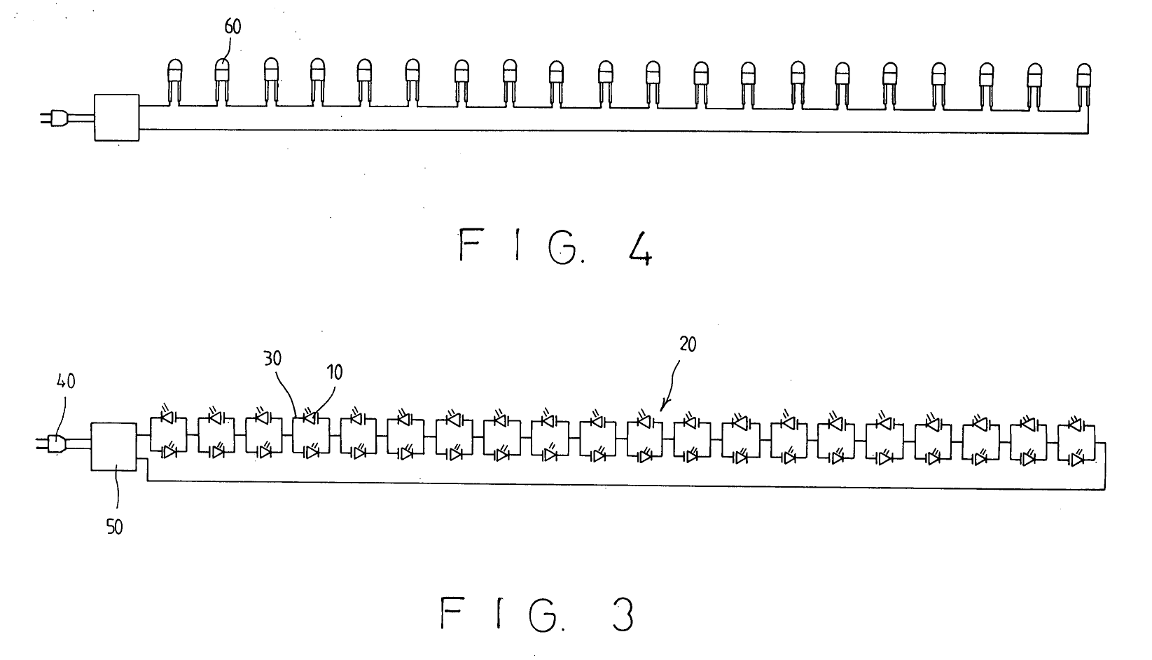

As indicated in to FIG. 3, the preferred embodiment in the present invention includes a lamp string (20) formed with multiple dual colored LED lamps (10) and a controller (50) connected between the power supply and the aforementioned lamp string. The LED lamp (10) has two different colors such as red and green, yellow and blue . . . etc. Two LED lamps (10) with different colors form a lamp group (30). In the first lamp group (30), the cathode of the first colored LED lamp is linked with the anode of the second colored LED, and the cathode of the second colored LED lamp is linked with the anode of the first colored LED lamp. That is, two LED lamps with different colors are formed cross-linked together with their anodes and cathodes in the same lamp group (30). Multiple of the aforementioned lamp groups are linked together to form an aforementioned lamp string (20). In the aforementioned lamp strings (20), the cathode of the first colored LED lamp in each lamp group (30) is linked with the anode of the second colored LED lamp in the next lamp group, and the anode of the second colored LED lamp is linked with the cathode of the second colored LED lamp in the next lamp group. That is, the serial connection point between each lamps group and the next lamp group is set at the cross linked points between dual color lamps in the same lamp group. A lamp string (20) is thus formed with a connection of same polarity between the first colored LED lamp in each lamp group and the second colored LED lamp in the next lamp group. The said lamp string (20) connected to the external power supply through a plug (40). The aforementioned controller (50) is set between the plug (40) and the lamp string (20). The controller (50) is able to control the change of current direction in the lamp string (20). While the current is flowed in the first kind of direction, the first colored LED lamp in the lamp string (20) is positively conducted and the second colored LED lamp is non-conducted in reverse, thus the aforementioned lamp string (20) emits the light with the first color. While the controller (50) controls the current direction to change to the second direction, the first colored LED lamp in the aforementioned lamp string (20) is non-conducted in reverse and the second colored LED lamp is positively conducted, thus the aforementioned lamp string (20) emits the light with the second color. Therefore, by the change of current direction through the controller (50), the same lamp string (20) is able to emit two kinds of colored lamp lights without the requirement of multiple lamp strings, thus the linking structure become simpler.

As indicated in to FIG. 4, in the aforementioned preferred embodiment of the dual colored LED decoration lamp in the present invention, the aforementioned two LED lamps in the same lamp group is able to be set in the same body (60), their mutual cross-linkage between anodes and cathodes is set inside the body (60) to allow the said lamp group to be set in the body (60) and the body (60) has only two guiding wires. Although the whole decoration lamp is still combined with two circuitries, there are only two conductive wires needed. Their volumes become smaller and weights become lighter, and they can be conveniently hanged or wrapped on the materials or at the sites needed to be decorated without the usages of special nails . . . etc. to support the weight or the fixed braces to fix these decoration lamps. Thus, the usage becomes more convenient and flexible.

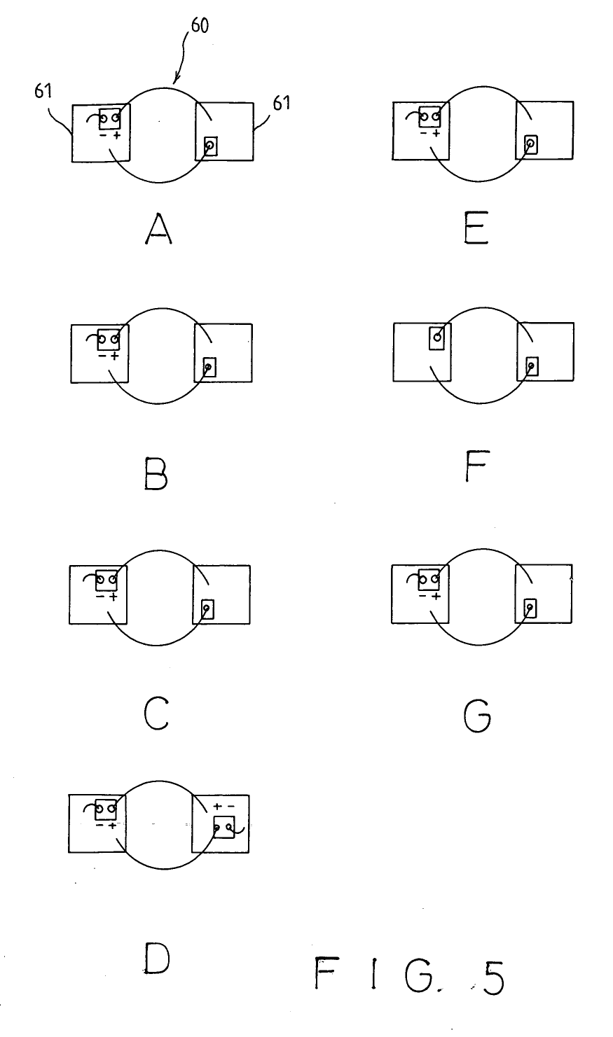

As indicated in to FIGS. 5A to 5G, there are implement methods of linking the anodes and cathodes of different colored LED lamps in the lamp body (60) to the brace (61) indicated in the aforementioned preferred embodiment of the dual colored LED decoration lamp in the present invention.

1-2. (canceled)

3. An LED decoration lamp comprising:
a lamp string including a plurality of lamp groups which are connected in series, said lamp string having a first end and a second end, each of said lamp groups having a first LED and a second LED, anode of said first LED being connected to cathode of said second LED, cathode of said second LED being connected to anode of said second LED, said first LED and said second LED being different in color;
a conductive wire having a first end and a second end, said first end of said conductive wire being connected with said first end of said lamp string; and
a controller having two output ends and two input ends, said output ends being connected with said second end of said conductive wire and said second end of said lamp string, said input ends being connected with a power supply;
wherein said controller controls current direction in said lamp string so that when current flows in a first direction, said first LED is positively conducted and said second LED is non-conducted thus causing said first LED to emit light, but when current flows in a second direction, said second LED is positively conducted and said first LED is non-conducted thus causing said second LED to emit light, and thereby said controller can control only said first LED or only said second LED of said lamp groups of said lamp string to emit light as desired, and therefore said controller can control said first or second LED to emit a single color, or control said first and second LED to emit light alternately, causing the lamp string to emit light of two colors.
